(19) United States
(12) Patent Application Publication
(10) Pub. No.: US 2024/0020527 A1
(43) Pub. Date: Jan. 18, 2024

(54) MACHINE LEARNING MODELING OF TIME SERIES WITH DIVERGENT SCALE

(71) Applicant: Home Depot Product Authority, LLC, Atlanta, GA (US)

(72) Inventor: David J. Chisnell, Atlanta, GA (US)

(21) Appl. No.: 17/863,882

(22) Filed: Jul. 13, 2022

(51) Int. Cl. G06N 3/08; G06N 3/04; G06K 9/62

(52) U.S. Cl. CPC G06N 3/08; G06N 3/0454; G06K 9/6201

(57) ABSTRACT

A method for predicting demand for a resource includes training a machine learning model, the machine learning model including a first portion that receives one or more time series, calculates a respective scale of each input time series, and outputs scaled time series, a second portion that receives the scaled time series and outputs a respective predicted future value of each scaled time series, and a third portion that de-scales each predicted future value of each scaled time series according to the scale of each input time series to generate final predicted future values. The method may further include deploying the trained machine learning model to predict a future demand of an additional resource given a time series of past demand of the additional resource.

### TECHNICAL FIELD

This disclosure generally relates to machine learning-based prediction of future values of a time series, including time series with divergent numerical scales.

### BACKGROUND

Classic statistical forecasting methods perform well on a single time series with sufficient historical data. However, many industries and applications involve forecasting for thousands of extremely diverse resources and resource usages, often split among thousands of geographic regions or other locations. The applied operational use of forecasts is thus caught between the choice of two extremes. One is a very large number of different forecasts, which is expensive to compute and maintain, while accuracy may be limited by the small number of records of usage for a single resource in a small area. The second is the desire to leverage the large number of independent series that exist to learn across all the series, most notably with deep-learning methods.

When modeling large numbers of these sequences, the most important data point remains the ongoing history of prior usage for that resource and region or other location. The individual resource and locations continue to behave as a time series and exhibit autocorrelation and autocovariance. The other drivers of behavior modify these expectations, but these effects will be a function of the scale of the original time series. This disparity creates an additional challenge driven by the presence of very large training updates for a small set of inputs, while the updates to most other inputs are very small by comparison.

### BRIEF DESCRIPTION OF THE DRAWINGS

FIG. 1 is a block diagram view of an example system for forecasting demand for a resource.

FIG. 2 is a flow chart illustrating an example method of predicting demand for and allocating a resource according to a predictive machine learning model.

FIG. 3 is a flow chart illustrating an example method for training a machine learning model to predict demand for a resource.

FIG. 4 is a diagrammatic view of an example structure of a machine learning model for predicting demand of a resource.

FIG. 5 is a diagrammatic view of an example embodiment of a user computing environment.

### DETAILED DESCRIPTION

The methods and machine learning approaches of this disclosure improve the process of generating resource demand forecasts by resource and location. The instant disclosure addresses the problem of accurately predicting future demand based on widely divergent scales in past usage of the resource. For example, the instant disclosure may include layering additional transformation to the standardization process based on a deep-learning solution that calculates—for any given series—the appropriate observation-level mean and standard deviation. This approach may share its loss function with a deep-learning forecasting solution, and loss may be calculated after reversing the internal observation-level standardization process.

In some embodiments, the disclosed demand-modeling technique may generate a demand model across widely divergent time series by first applying an encoding neural network across inputs to generate a new observation-specific center and observation-specific scale term for each input sequence. The observation-specific center and observation-specific scale terms may be applied at the beginning of a deep-learning forecasting solution and then reversed prior to calculating the overall loss of the network. A single loss may be calculated so the deep-learning processes are optimized together and converge toward the level of rescaling that maximizes overall performance.

The resulting process may generate a more accurate resource demand estimate for operational deployment as a baseline to measure changes resulting from future demand influences, as well as planning inventory or other volume-driven behavior decisions.

Inputs to a deep-learning architecture may be standardized or normalized. This may be done once for each input feature; for example, once for historic resource usage, once for historic resource supply, and so on. A standardized input will have a single scalar mean μ and standard deviation a, such that Usage_{standardized}=(Usage−μ_{Usage})/σ_{Usage}. If normalization is used instead, a normalized input is calculated as a fraction of the maximum observed value in the training data so Usage_{Normalized}=Usage/Max_{Usage}. These transformations may improve neural network training because the weight updates that constitute the learning process are based on gradients, which are calculated on the loss for a given input distributed across each weight. If input features are at widely different scales inside the network, the cases where the inputs are very large respond drastically to very small updates, while the network also requires large updates to include very small features. Keeping inputs at a similar scale smooths the loss function, significantly improves training time, and facilitates convergence at a consistent level of detail and depth.

One use case for the teachings of the present disclosure is a large retail enterprise, where the diversity of products may create extreme cases that can benefit from special handling because the wide range of values will be most heavily dependent on the historic series that establishes the level and trend in the market. Product sales may vary wildly in the base scale, with items like moving boxes selling hundreds of units per week, while more specialized, or long-lasting products, such as lawn-mower blades, might sell only one or two units per week. It is important to note that these differences are largely consistent. The scale of both sales and deviations may be a function of the product and geographic area. A difference in baseline sales between different products of 100× is not uncommon. Although certain examples and descriptions herein are respective of a retail environment, it should be understood that the teachings of the present disclosure are applicable to a wide variety of resource types, as disclosed herein.

An example technique for deep learning to address the impact of many regressors on a time series is to condition the time series ahead of time. By defining a specific level and trend ahead of time, the network can focus on the effects that modify this core series. For the case of a single time series with sufficient data, this combination of traditional time series and deep learning may be effective. However, with many time series of different scales, differences arise in the distribution of the error between fitting different time series. This error would be in the training labels for the network. With many observations from a single time series, these errors have generally been shown to be consistent enough for effective machine learning. In the case of many different time series, fitting each series independently introduces a larger random element that increases the inconsistencies in the data and makes learning the impact of features across many time series far more difficult. Further, finding the ideal model that is a good fit across all series is a significant modeling effort in its own right.

Consider the impact of these issues on measuring the impact of a demand driver, such as a price change for a resource, on predicted demand. The basic result of a price change is a function of the size of the price change and the price elasticity, or a percentage change in demand to a percentage change in price. Implicit is the assumption that the impact of a price change results in a percentage change. When learning across products where one product is inherently expected to sell at least 100× the sales of another product, the differences in impact from all of these marginal effects would have 1/100th the impact of an improvement in the fitting of the baseline trend. The difference in order of magnitude makes updates to weights pertaining to these inputs tiny and difficult to converge while the baseline is still training. The initial standardization or normalization was intended to solve the problem updates of massively different sizes. This problem persists for these time series, driven by the fundamental difference in the importance of the input.

The approaches described herein may integrate the concept of a previously modeled scale for a given location and resource into the primary forecasting method to generate a demand model which learns more efficiently across widely divergent series. The first layers of the network may include an encoding-style neural network that accepts long-term historic usage and other key inputs where the network outputs are forced into matrices representing a new center and scale for each observation input series in relation to unit sales.

Modelling demand according to the present disclosure provides many benefits. The first benefit is directly sharing the loss function. Pre-calculating any separate scale values requires that they have some separate loss, either an error function on the real training labels, treating them as pseudo-models, or a simplification that attempts to match level. Both of these options would have to include—as either part of the term or part of the error—the impact of any complex features that raises or lowers the average because they would not be fit on the sparse data in a single series. The impact of these features has to be measured by the subsequent model in two parts: how they moved the center point of precalculated scale, and the impact of the features themselves. In contrast, if the loss is shared, the updates for the impact of features are applied simultaneously, and the scale of individual product SKUs and stores converge on a solution where the scale is most efficient in conjunction with solving for the identified features.

The second benefit is operational. By merging this process into the network, the following resources are not needed: retraining, separate evaluation by a data scientist of the initial model performance, and the need to store and transfer modified data between the processes. For large scale samples, with tens of thousands of individual resources at hundreds or thousands of locations with hundreds of time steps, this approach can speed the prediction process by a day or more and reduce the need for interstitial saving and transportation by terabytes.

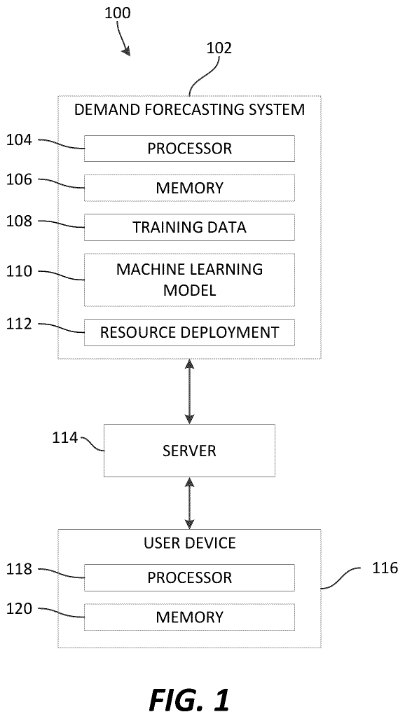

Referring now to the drawings, wherein like numerals refer to the same or similar features in the various views, FIG. 1 is a system 100 that includes a demand forecasting system 102 that itself includes a processor 104 and a non-transitory, computer-readable memory 106. The memory 106 stores instructions that, when executed by the processor, cause the demand forecasting system 102 to perform one or more steps, methods, algorithms, etc. of this disclosure.

The demand forecasting system 102 may include a set of training data 108, which may include raw data respective of use of one or more resources. For example, the training data 108 may include time series of past usage of a one resource, or of a plurality of resources. The training data 108 may include time series of past usage respective of a single location or other deployment of a resource, or of many locations or other deployments of a resource. The many time series may have data points of different scale (e.g., where the values of one time series are more than an order of magnitude larger than values of another time series, for example). As will be discussed below, part of the process of training a machine learning model according to the training data 108 may include scaling the training data 108 and/or performing other operations on the training data, as disclosed herein. The resource of which the training data 108 is respective may be any resource amenable to predictions of future usage. For example, the resource may be a computing resource, a natural resource, a human resource (e.g., quantity of personnel, hours, etc.), an equipment resource, inventory, supplies, etc.

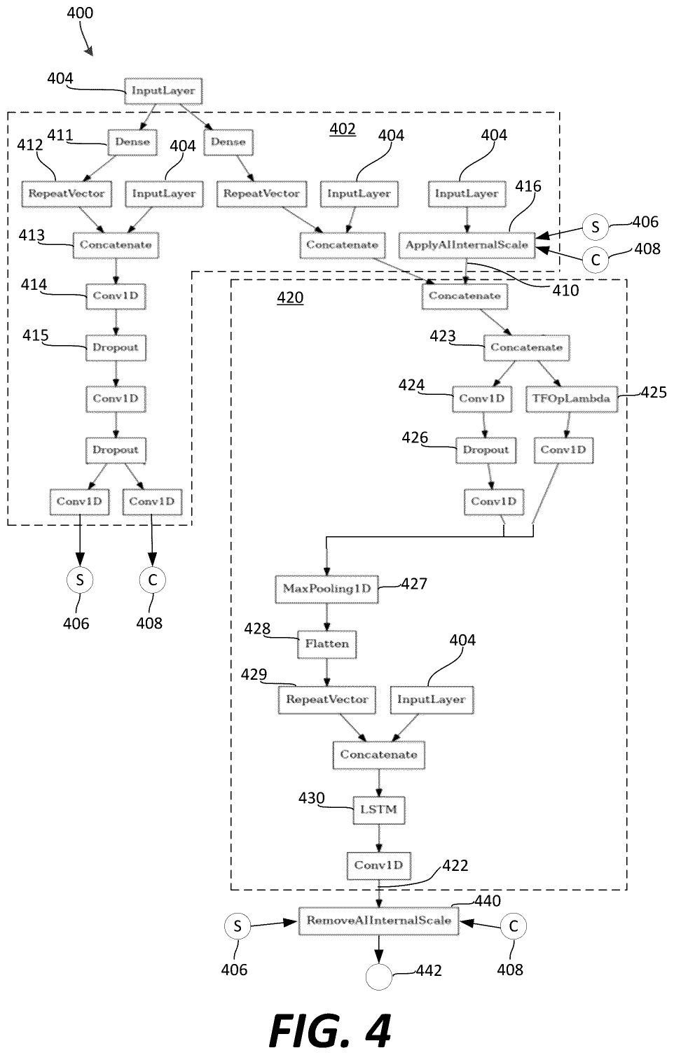

The demand forecasting system 102 may further include a machine learning model 110 that may be configured to receive, as input, one or more time series of past demand of a resource and to output a predicted future demand of the resource. The model may include, for example, one or more convolutional neural networks (CNNs). An example model will be discussed below with respect to FIG. 4.

The demand forecasting system 102 may further include a resource deployment module 112. The resource deployment module 112 may be configured to transmit instructions to deploy a volume of the resource necessary to meet the predicted future demand. For example, where the resource is a computing resource, the resource deployment module 112 may be configured to assign the necessary computing resources to the needed task, or to process the needed task with the necessary computing resources. Where the resource is a human resource, the resource deployment module 112 may contact the necessary human resources to assign those human resources to the desired task, or may output a list of the human resources that would meet the predicted demand. Where the resource is an inventory or supply, the resource deployment module may generate an order for the predicted demand of the inventory or supply, and/or transmit such an order, and/or output one or more parameters of such an order. Accordingly, regardless of the resource, the resource deployment module 112 may cause the predicted demand for the resource to be met.

In some embodiments, the resource deployment module 112 may expose an application programming interface (API) that provides user access to the machine learning model 110. For example, the API may provide access to one or more input portions of the machine learning model, and may output one or more outputs from the machine learning model to the user, in a graphical user interface specific to the user. Through such an API, the user may enter different input sets and observe changes in the model output to assess the appropriate resources that may be required.

The system may further include a server 114 in communication with the demand forecasting system 102 and with one or more user devices 116. Each user device 116 may access the demand forecasting system 102 via the server 114, in some embodiments. Each user device 116 may include processor 118 and a memory 120. The memory 120 stores instructions that, when executed by the processor 118, cause the user device 116 to perform one or more steps, methods, algorithms, etc. of this disclosure. For example, a user device 116 may include a resource deployment module 112, in some embodiments.

In operation, a user may provide a time series of prior demand for a resource to the demand forecasting system 102 via a user device 116. The demand forecasting system 102 may input the provided time series to the machine learning model 110, which model 110 may output a predicted future demand for the resource. The model 110 may have been trained according to the training data 108. The predicted future demand may be output to the user device 116, in some embodiments. Additionally or alternatively, the predicted future demand may be input to the resource deployment module 112, which may cause deployment of the resource necessary to meet the predicted future demand.

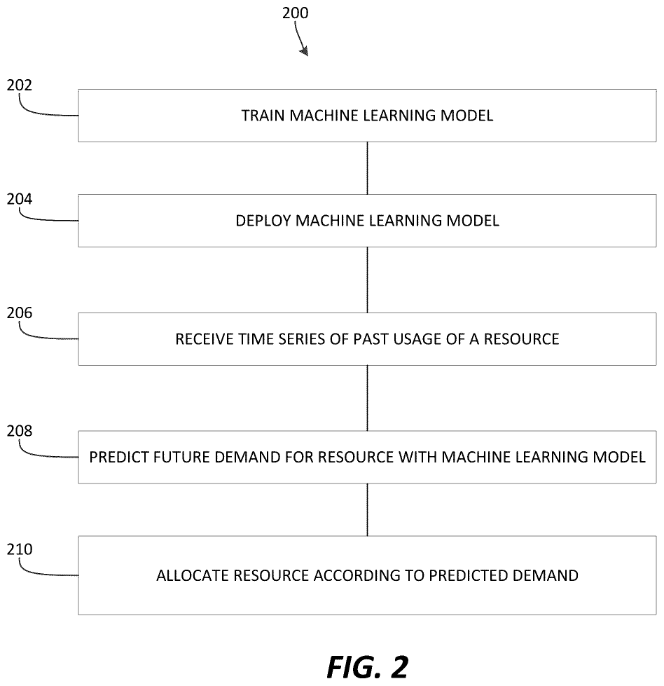

FIG. 2 is a flow chart illustrating an example method 200 of predicting demand for and allocating a resource according to a predictive machine learning model. The method 200, or one or more portions of the method 200, may be performed by the demand forecasting system 102, in some embodiments.

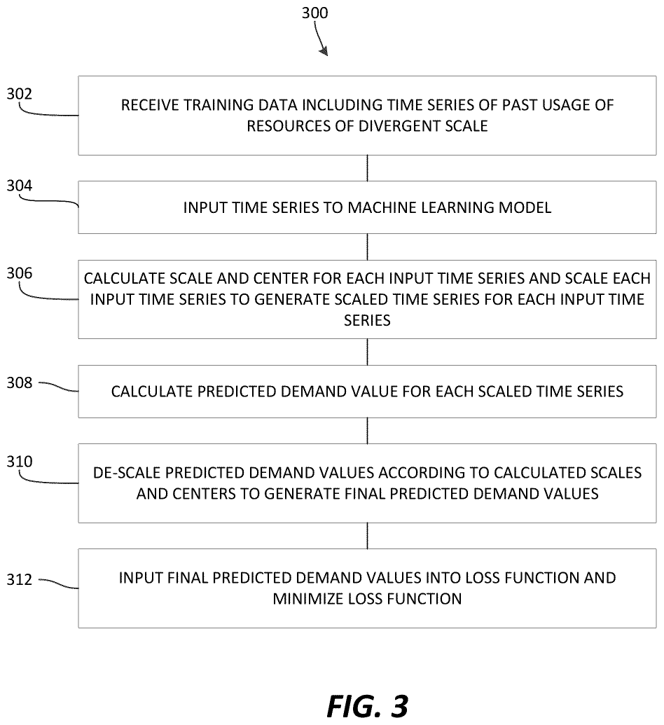

The method 200 may include, at block 202, training a machine learning model. An example method of training a machine learning model is described below with respect to FIG. 3. The machine learning model may be trained based on time series of a particular resource, in some embodiments, such that the model is trained to predict demand of that particular resource. In other embodiments, the machine learning model may be trained on time series respective of multiple resources, such that the model is trained to predict a demand of an arbitrary resource, or any one of the resources that are a subject of the training data.

The method 200 may further include, at block 204, deploying the trained machine learning model. Deploying the trained machine learning model may include making the model accessible to one or more users (e.g., via a server), in some embodiments. Additionally or alternatively, deploying the trained machine learning model may include providing the trained model for a user device to install for local execution.

The method 200 may further include, at block 206, receiving a time series of past usage of a resource. The time series may be received from a user. The time series may be respective of the resource (or one of the resources) that is the subject of the training data used at block 202. The time series may be respective of the location (or one of the locations) that is the subject of the training data used at block 202. The time series received at block 206 may be different from any time series used as training data at block 202, in some embodiments.

The method 200 may further include, at block 208, predicting a future demand for the resource that is the subject of the time series received at block 206 with the trained machine learning model. Block 208 may include inputting the time series received at block 206 to the machine learning model trained at block 204, with the output of the trained machine learning model being or including a predicted future demand of the resource. In some embodiments, the quantity of outputs may be a single predicted future demand value. In other embodiments, the quantity of outputs may be a plurality of future demand values for a resource, such as a plurality of different time points for the resource. For example, between twelve (12) and fifty-two (52) outputs may be generated by the machine learning model and output to the user, for example.

The method 200 may further include, at block 210, allocating the resource according to the predicted demand predicted at block 208. For example, where the resource is a computing resource, block 210 may include assigning the necessary computing resources to the needed task, or processing the needed task with the necessary computing resources. Where the resource is a human resource, block 210 may include automatically contacting the necessary human resources to assign those human resources to the desired task, or may include outputting a list of the human resources that would meet the predicted demand. Where the resource is an inventory or supply, block 210 may include automatically generating an order for the predicted demand of the inventory or supply, and/or transmitting such an order, and/or outputting one or more parameters of such an order.

In some embodiments, blocks 202 and 204 may be performed once, and blocks 206, 208, 210 may be performed numerous times using the trained and deployed machine learning model. Accordingly, a user may access a trained and deployed machine learning model to predict demand and allocate resources for a resource at many different times, for many different locations or other deployments, etc. Additionally or alternatively, a user may access a trained and deployed machine learning model to predict demand and allocate resources for many different resource types.

FIG. 3 is a flow chart illustrating an example method 300 for training a machine learning model to predict demand for a resource. The method 300, or one or more portions of the method 300, may be performed by the demand forecasting system 102, in some embodiments.

The method 300 may include, at block 302, receiving training data that includes respective time series of divergent scale of past usage of one or more resources. In some embodiments, the time series received at block 302 may all be respective of the same resource, but may be respective of usage of the resource at different points in time, for different purposes (e.g., locations, projects, etc.), or otherwise different time series of the same resource. In some embodiments, the time series received at block 302 may be respective of different resources. In some embodiments, a scale of past resource usage of a first one of the time series may be at least 100 times greater than a scale of past resource usage of a second one of the time series.

The method 300 may further include, at block 304, inputting each time series received at block 302 to a machine learning model. Block 304 may include inputting each time series to one or more portions of the model. For example, block 304 may include inputting each time series to a first portion of the model that calculates a scale and a center of each time series and inputting each time series to a second portion of the model that calculates a predicted demand of the subject resource for each time series.

The method 300 may further include, at block 306, calculating a scale and center for each time series input at block 304 and scaling each value of each input time series to generate a respective scaled time series for each input time series. Block 306 may include, for example, calculating the scale and center with a first portion of the machine learning model and generating the scaled time series with a second portion of the machine learning model. For example, block 306 may include calculating center C^{x} for each time series x and scale S^{x} for each time series x. Block 306 may include, for example, generating a plurality of vectors (e.g., a respective vector for each time series, with values scaled according to C^{x} and S^{x}) for each batch of time series with a value for each time series x.

The method 300 may further include, at block 308, calculating a predicted demand value for each scaled time series. The predicted demand value may be or may be included in an output of the machine learning model.

The method 300 may further include, at block 310, de-scaling the predicted demand values according to the calculated scales and centers determined at block 306 to generate final predicted demand values respective of the input time series. Block 310 may include, for example, comparing data points from the time series of past usage of a first subset of the resources to the final predicted future value respective of the first subset of resources. In some embodiments, block 310 may include applying a respective scale associated with a given resource to a prediction associated with the given resource. For example, block 310 may include subtracting C^{x} from the past values of resource usage (U) such that the historic resource usage may be expressed according to equation (1) below:

U_{feature}^{x}=U_{standardized}^{x}−Cᵤ^{x})/Sᵤ^{x} (Eq. 1)

The method 300 may further include, at block 312, inputting the final predicted demand values into a loss function and minimizing the loss function. In some embodiments, block 312 may include applying the scale Sᵤ^{x} to the output sequence of the neural network that will be compared to the true resource usage to generate the neural network loss. The loss function is still subject to the original standardization across all inputs done in preprocessing, but not the observation level standardization done inside the neural network. Predicted future values used for calculating a forecast error or network loss may be calculated according to equation 2 below:

$${loss}^{x} = {y}^{x} - {\hat{y}}_{predicted}^{x} = {y}^{x} - \frac{{\hat{\hat{y}}}_{o u t p u t}^{x}}{{s}_{u}^{x}} - {C}_{u}^{x} \qquad ( Eq . 2 )$$

FIG. 4 is a diagrammatic view of an example structure of a machine learning model 400 for predicting demand of a resource. The model 400 is an example embodiment of the model 110 of FIG. 1.

The model 400 may include a first portion 402 that receives, as input, one or more time series 404, calculates a respective scale 406 and a respective center 408 of each input time series 404, and outputs a respective scaled time series 410 for each input time series 404. In some embodiments, the first model portion 402 may calculate a respective center 408 for each input time series 404. In some embodiments, the first model portion 402 may be or may include a convolutional neural network (CNN). The first model portion 402 may include a plurality of layers such as, for example, one or more dense layers 411, a one or more repeat vector layers 412, one or more concatenation layers 413, one or more one-dimensional convolution layers 414, one or more dropout layers 415, and a scaling layer 416 that generates the scaled time series 410 based on the input time series 404, and the calculated scales 406 and centers 408 Sᵤ^{x} and Cᵤ^{x}. Although numerous iterations of some of the layer types 411, 412, 413, 414, 415 are included in the first model portion 402, only a single iteration of each layer type is indicated with its respective numeral in FIG. 4 for clarity of illustration.

The model 400 may further include a second model portion 420 that receives, as input, the one or more scaled time series 410 and outputs a respective predicted future value 422 of each scaled time series 410. In some embodiments, the second model portion 420 may be or may include a convolutional neural network (CNN). The second model portion 420 may include a plurality of layers such as, for example, one or more concatenation layers 423, one or more one-dimensional convolutional layers 424, one or more lambda layers 425, one or more dropout layers 426, one or more max pooling layers 427, one or more flattening layers 428, one or more repeat vector layers 429, and one or more long-short term memory layers 430. Although numerous iterations of some of the layer types 423, 424 are included in the second model portion 420, only a single iteration of each layer type is indicated with its respective numeral in FIG. 4 for clarity of illustration.

The model 400 may further include a third portion 440 that de-scales each predicted future value 422 of each scaled time series according to the calculated respective scale of each input time series to generate a respective final predicted future value 442 of each input time series. In some embodiments, the third model portion 440 may de-scale each predicted future value of each scaled time series according to the calculated respective scale 406 and the calculated respective center 408 of each input time series 404.

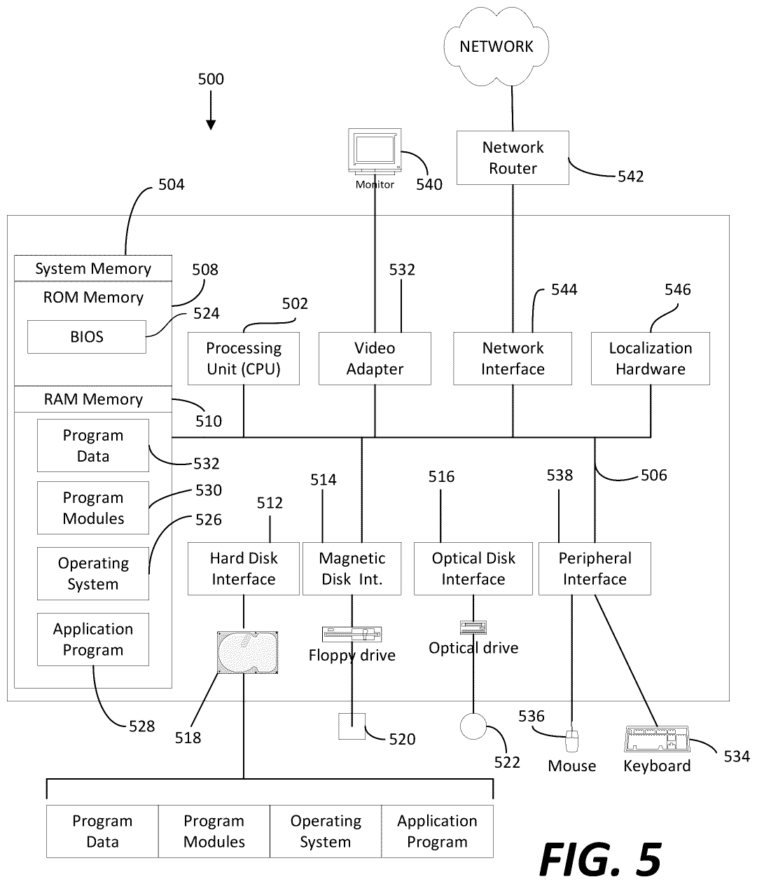

FIG. 5 is a diagrammatic view of an example embodiment of a user computing environment that includes a general purpose computing system environment 500, such as a desktop computer, laptop, smartphone, tablet, or any other such device having the ability to execute instructions, such as those stored within a non-transient, computer-readable medium. Furthermore, while described and illustrated in the context of a single computing system 500, those skilled in the art will also appreciate that the various tasks described hereinafter may be practiced in a distributed environment having multiple computing systems 500 linked via a local or wide-area network in which the executable instructions may be associated with and/or executed by one or more of multiple computing systems 500.

In its most basic configuration, computing system environment 500 typically includes at least one processing unit 502 and at least one memory 504, which may be linked via a bus 506. Depending on the exact configuration and type of computing system environment, memory 504 may be volatile (such as RAM 510), non-volatile (such as ROM 508, flash memory, etc.) or some combination of the two. Computing system environment 500 may have additional features and/or functionality. For example, computing system environment 500 may also include additional storage (removable and/or non-removable) including, but not limited to, magnetic or optical disks, tape drives and/or flash drives. Such additional memory devices may be made accessible to the computing system environment 500 by means of, for example, a hard disk drive interface 512, a magnetic disk drive interface 514, and/or an optical disk drive interface 516. As will be understood, these devices, which would be linked to the system bus 506, respectively, allow for reading from and writing to a hard disk 518, reading from or writing to a removable magnetic disk 520, and/or for reading from or writing to a removable optical disk 522, such as a CD/DVD ROM or other optical media. The drive interfaces and their associated computer-readable media allow for the nonvolatile storage of computer readable instructions, data structures, program modules and other data for the computing system environment 500. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 500.

A number of program modules may be stored in one or more of the memory/media devices. For example, a basic input/output system (BIOS) 524, containing the basic routines that help to transfer information between elements within the computing system environment 500, such as during start-up, may be stored in ROM 508. Similarly, RAM 510, hard drive 518, and/or peripheral memory devices may be used to store computer executable instructions comprising an operating system 526, one or more applications programs 528 (which may include the functionality of the demand forecasting system 102 of FIG. 1 or one or more of its functional module 112, for example), other program modules 530, and/or program data 522. Still further, computer-executable instructions may be downloaded to the computing environment 500 as needed, for example, via a network connection.

An end-user may enter commands and information into the computing system environment 500 through input devices such as a keyboard 534 and/or a pointing device 536. While not illustrated, other input devices may include a microphone, a joystick, a game pad, a scanner, etc. These and other input devices would typically be connected to the processing unit 502 by means of a peripheral interface 538 which, in turn, would be coupled to bus 506. Input devices may be directly or indirectly connected to processor 502 via interfaces such as, for example, a parallel port, game port, firewire, or a universal serial bus (USB). To view information from the computing system environment 500, a monitor 540 or other type of display device may also be connected to bus 506 via an interface, such as via video adapter 532. In addition to the monitor 540, the computing system environment 500 may also include other peripheral output devices, not shown, such as speakers and printers.

The computing system environment 500 may also utilize logical connections to one or more computing system environments. Communications between the computing system environment 500 and the remote computing system environment may be exchanged via a further processing device, such a network router 542, that is responsible for network routing. Communications with the network router 542 may be performed via a network interface component 544. Thus, within such a networked environment, e.g., the Internet, World Wide Web, LAN, or other like type of wired or wireless network, it will be appreciated that program modules depicted relative to the computing system environment 500, or portions thereof, may be stored in the memory storage device(s) of the computing system environment 500.

The computing system environment 500 may also include localization hardware 586 for determining a location of the computing system environment 500. In embodiments, the localization hardware 546 may include, for example only, a GPS antenna, an RFID chip or reader, a WiFi antenna, or other computing hardware that may be used to capture or transmit signals that may be used to determine the location of the computing system environment 500.

The computing environment 500, or portions thereof, may comprise one or more components of the system 100 of FIG. 1, in embodiments.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A method for predicting demand for a resource, the method comprising:
training a machine learning model, the machine learning model comprising:
a first portion that receives, as input, one or more time series, calculates a respective scale of each input time series, and outputs a respective scaled time series for each input time series;
a second portion that receives, as input, the one or more scaled time series and outputs a respective predicted future value of each scaled time series; and
a third portion that de-scales each predicted future value of each scaled time series according to the calculated respective scale of each input time series to generate a respective final predicted future value of each input time series;
wherein training the machine learning model comprises inputting a respective time series of past usage of each of a plurality of resources to the machine learning model; and
deploying the trained machine learning model to predict a future demand of an additional resource given a time series of past demand of the additional resource.

2. The method of claim 1, wherein training the machine learning model further comprises:
inputting the output of the third portion of the model to a loss function; and
minimizing the loss function.

3. The method of claim 2, wherein inputting the output of the third portion of the model to the loss function comprises comparing data points from the time series of past usage of a first subset of the resources to the final predicted future value respective of the first subset of resources.

4. The method of claim 1, wherein a scale of past usage of a first one of the resources is at least 100 times greater than a scale of past usage of a second one of the resources.

5. The method of claim 1, wherein applying the scale of each time series to the output of the second portion of the model comprises applying a respective scale associated with a given resource to a prediction associated with the given resource.

6. The method of claim 1, wherein the first model portion comprises a convolutional neural network (CNN).

7. The method of claim 1, wherein the second model portion comprises a convolutional neural network (CNN).

8. The method of claim 1, wherein:
the first model portion further calculates a respective center for each input time series; and
the third portion de-scales each predicted future value of each scaled time series according to the calculated respective scale and the calculated respective center of each input time series.

9. A system comprising:
a non-transitory, computer-readable memory storing instructions; and
a processor configured to execute the instructions to cause the system to:
train a machine learning model, the machine learning model comprising:
a first portion that receives, as input, one or more time series, calculates a respective scale of each input time series, and outputs a respective scaled time series for each input time series;
a second portion that receives, as input, the one or more scaled time series and outputs a respective predicted future value of each scaled time series; and
a third portion that de-scales each predicted future value of each scaled time series according to the calculated respective scale of each input time series to generate a respective final predicted future value of each input time series;
wherein training the machine learning model comprises inputting a respective time series of past usage of each of a plurality of resources to the machine learning model; and
deploy the trained machine learning model to predict a future demand of an additional resource given a time series of past demand of the additional resource.

10. The system of claim 9, wherein training the machine learning model further comprises:
inputting the output of the third portion of the model to a loss function; and
minimizing the loss function.

11. The system of claim 10, wherein inputting the output of the third portion of the model to the loss function comprises comparing data points from the time series of past usage of a first subset of the resources to the final predicted future value respective of the first subset of resources.

12. The system of claim 9, wherein a scale of past usage of a first one of the resources is at least 100 times greater than a scale of past usage of a second one of the resources.

13. The system of claim 9, wherein applying the scale of each time series to the output of the second portion of the model comprises applying a respective scale associated with a given resource to a prediction associated with the given resource.

14. The system of claim 9, wherein the first model portion comprises a convolutional neural network (CNN).

15. The system of claim 9, wherein the second model portion comprises a convolutional neural network (CNN).

16. The system of claim 9, wherein:
the first model portion further calculates a respective center for each input time series; and
the third portion de-scales each predicted future value of each scaled time series according to the calculated respective scale and the calculated respective center of each input time series.

17. The system of claim 9, wherein the memory stores further instructions that, when executed by the processor, cause the processor to:
calculate a respective standardized value for each data point in each of the one or more time series;
wherein the first portion that receives, as input, the standardized values.

18. A system comprising:
a non-transitory, computer-readable memory storing instructions; and
a processor configured to execute the instructions to cause the system to:
deploy a machine learning model comprising:
a first portion that receives, as input, one or more time series, calculates a respective scale of each input time series, and outputs a respective scaled time series for each input time series;
a second portion that receives, as input, the one or more scaled time series and outputs a respective predicted future value of each scaled time series; and
a third portion that de-scales each predicted future value of each scaled time series according to the calculated respective scale of each input time series to generate a respective final predicted future value of each input time series;
input a time series of past demand of an additional resource to the deployed machine learning model; and
output a predicted future demand for the additional resource output by the deployed machine learning model.

19. The system of claim 18, wherein:
the first model portion further calculates a respective center for each input time series; and
the third portion de-scales each predicted future value of each scaled time series according to the calculated respective scale and the calculated respective center of each input time series.

20. The system of claim 18, wherein the memory stores further instructions that, when executed by the processor, cause the processor to:
calculate a respective standardized value for each data point in each of the one or more time series;
wherein the first portion that receives, as input, the standardized values.
